(19) United States
(12) Patent Application Publication
(10) Pub. No.: US 2019/0077577 A1
(43) Pub. Date: Mar. 14, 2019

(54) Softside Cooler with External LED Lighting

(71) Applicant: Visual Promotions, LLC, Sealy, TX (US)

(72) Inventor: Jeffrey William Brandes, Cat Spring, TX (US)

(21) Appl. No.: 16/128,141

(22) Filed: Sep. 11, 2018

Related U.S. Application Data
(60) Provisional application No. 62/556,767, filed on Sep. 11, 2017.

(51) Int. Cl. B65D 81/38; F25D 27/00; F21S 4/24; H02J 7/00

(52) U.S. Cl. CPC B65D 81/3893; F25D 27/00; F21S 9/02; H02J 7/0052; F25D 2400/12; F21S 4/24

(57) ABSTRACT

An insulated container including a plurality of flexible layers coupled together to form a body of the insulated container. The plurality of flexible layers includes an outer shell. The insulated container includes a plurality of segments coupled to an exterior surface of the outer shell. Each of the plurality of segments forms a loop. The insulated container includes a plurality of flexible straps coupled to the exterior surface of the outer shell. Each of the flexible straps provides a channel along a longitudinal axis of the insulated container. The insulated container includes a lighting strip passing through the loop formed by each of the plurality of segments and through the channel provided by each of the flexible straps to secure the lighting strip to the insulated container. The insulated container may also include a removable lighted speaker configured to be coupled to, and temporarily decoupled from, the outer shell.

### CROSS-REFERENCE TO RELATED APPLICATIONS

This patent application claims the benefit of U.S. Provisional Patent Application No. 62/556,767, filed Sep. 11, 2017, by Jeffrey William Brandes, and titled “Softside Cooler with External LED Lighting,” the teaching and disclosure of which is hereby incorporated in its entirety by reference thereto.

### BACKGROUND

Portable thermally insulated containers or coolers have become popular for carrying articles and perishable foods that are best served cool, most commonly beverages, but also things like salads, sandwiches, and other perishable foods that are intended to be kept cool until consumed. Portable thermally insulated containers can either be a hard shelled/hard sided insulated cooler or a soft sided/soft shelled insulated cooler bag. Hard shelled insulated coolers are made of molded plastic and can be substantially rigid and, as a result, depending on their size, not very portable or packable for trips to the beach or the park. Soft sided cooler bags, on the other hand, are made from generally flexible fabrics so that the soft sided coolers can be collapsible and erectable by, for example, folding down side panels, thereby making them much more transportable than hard shell coolers.

### SUMMARY

In an embodiment, the disclosure includes an insulated container, comprising: a plurality of flexible layers coupled together to form a body of the insulated container, wherein the plurality of flexible layers comprises an outer shell; a plurality of segments coupled to an exterior surface of the outer shell, wherein each of the plurality of segments forms a loop; a plurality of flexible straps coupled to the exterior surface of the outer shell, wherein each of the flexible straps provides a channel along a longitudinal axis of the insulated container; and a lighting strip passing through the loop formed by each of the plurality of segments and through the channel provided by each of the flexible straps to secure the lighting strip to the insulated container.

In an embodiment, the disclosure includes an insulated container, comprising: a plurality of flexible layers coupled together to form a body of the insulated container, wherein the plurality of flexible layers comprises an outer shell; and a removable lighted speaker configured to be coupled to, and temporarily decoupled from, the outer shell.

In an embodiment, the disclosure includes an insulated container, comprising: a plurality of flexible layers coupled together to form a body of the insulated container, wherein the plurality of flexible layers comprises an outer shell; a removable lighted speaker configured to be coupled to, and temporarily decoupled from, the outer shell; a plurality of segments coupled to an exterior surface of the outer shell, wherein each of the plurality of segments forms a loop; a plurality of flexible straps coupled to the exterior surface of the outer shell, wherein each of the flexible straps provides a channel along a longitudinal axis of the insulated container; and a lighting strip passing through the loop formed by each of the plurality of segments and through the channel provided by each of the flexible straps to secure the lighting strip to the insulated container.

### BRIEF DESCRIPTION OF DRAWINGS

For a more complete understanding of this disclosure, reference is now made to the following brief description, taken in connection with the accompanying drawings and detailed description, wherein like elements are numbered alike in the several FIGURES.

FIG. 1A is a front perspective view of a softsided cooler bag according to an embodiment.

FIG. 1B is another front perspective view of the softsided cooler bag of FIG. 1A according to an embodiment.

FIG. 2A is a rear perspective view of the softsided cooler bag of FIG. 1A according to an embodiment.

FIG. 2B is another rear perspective view of the softsided cooler bag of FIG. 2A according to an embodiment.

FIG. 3 is a perspective view of the lighting strip of the softsided cooler bag of FIG. 1A according to an embodiment.

FIG. 4A is a rear partial perspective view of the softsided cooler bag of FIG. 1A according to an embodiment.

FIG. 4B is a rear partial perspective view of the softsided cooler bag of FIG. 1A according to an embodiment.

FIG. 5A is a left side partial perspective view of the softsided cooler bag of FIG. 1A according to an embodiment.

FIG. 5B is another left side partial perspective view of the softsided cooler bag of FIG. 1A according to an embodiment.

FIG. 6A is a front perspective view of a main mesh pocket of the softsided cooler bag of FIG. 1A according to an embodiment.

FIG. 6B is another perspective view of the main mesh pocket of FIG. 6A according to an embodiment.

FIG. 6C is a perspective view of hidden pocket inside the main mesh pocket of FIG. 6A according to an embodiment.

FIG. 6D is another perspective view of hidden pocket inside the main mesh pocket of FIG. 6A according to an embodiment.

FIG. 7 is a top perspective view of a wireless controller according to an embodiment.

FIG. 8 is a cross-section view of the layers of the softsided cooler bag of FIG. 1A according to an embodiment.

FIG. 9A is a perspective view of a lighted removable speaker for use with the softsided cooler bag of FIG. 1A according to an embodiment.

FIG. 9B is a perspective view of the lighted removable speaker of FIG. 9A being rotated for removal according to an embodiment.

FIG. 9C is a perspective view of the lighted removable speaker when decoupled from the softsided cooler bag of FIG. 1A according to an embodiment.

FIG. 9D is another perspective view of the lighted removable speaker when decoupled from the softsided cooler bag of FIG. 1A according to an embodiment.

### DETAILED DESCRIPTION OF EMBODIMENTS

At times, these insulated coolers may be used while camping outdoors at night and there may be a need to illuminate the cooler so that it may be located quickly and conveniently. Attaching illuminating lights to hard shelled coolers is generally straightforward as the molded plastic of the hard shelled cooler provides a relatively non-deformable base for receiving external or internal illuminating lights. These lights can be embedded in recesses in the molded plastic thereby making these lights less prone to contamination and eventually degrade. However, it is not easy to attach illuminating lights to softsided coolers. With softsided coolers, the flexible fabric is not rigid enough to support reliably attaching illuminating lights and preventing these from separating from the cooler bag due to the constant flexing of the exterior flexible shell over time. For example, lights may be attached using pressure sensitive glue, hook and loop attachment alone, or other similar attachment means. However, these attachment methods may fail when dust, dirt, and/or moisture penetrates the connecting surface between the light and the cooler bag. An improved softsided cooler with external lights that are not prone to failure would be well received in the art.

Disclosed herein is an improved softsided cooler bag with a light emitting diode (LED) lighting strip and a removable lighted speaker. The LED lighting strip may illuminate an exterior of the cooler bag. Also, the removable lighted speaker may be selectively attachable and detachable to the exterior of the softsided cooler. In embodiments, additional LED lighting strips may be provided within the interior of the bag, or at other locations of the exterior of the cooler bag. The softsided cooler bag is flexible and includes strategically placed loops to securely hold the LED lighting strip in place circumferentially around an outside surface of the softsided cooler bag. A plurality of pocket cavities are provided for securely holding items and a battery box containing one or more batteries that supply power to the LED lighting strip.

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

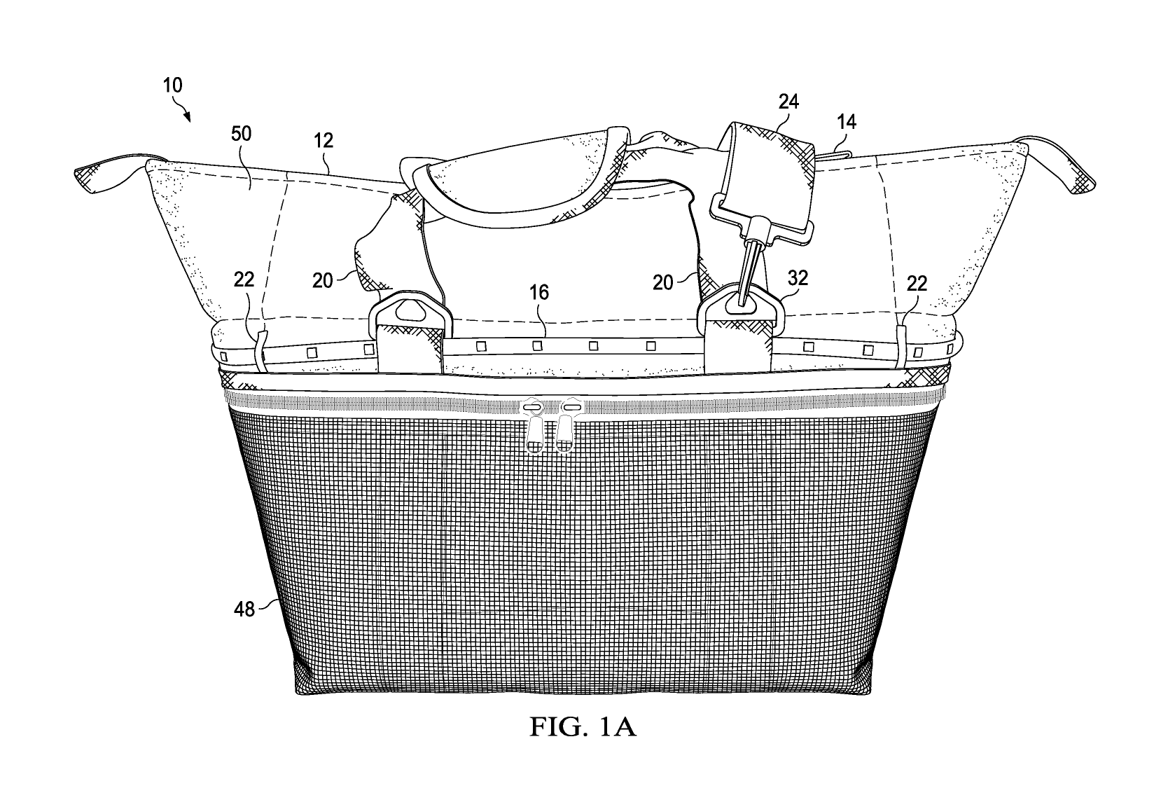

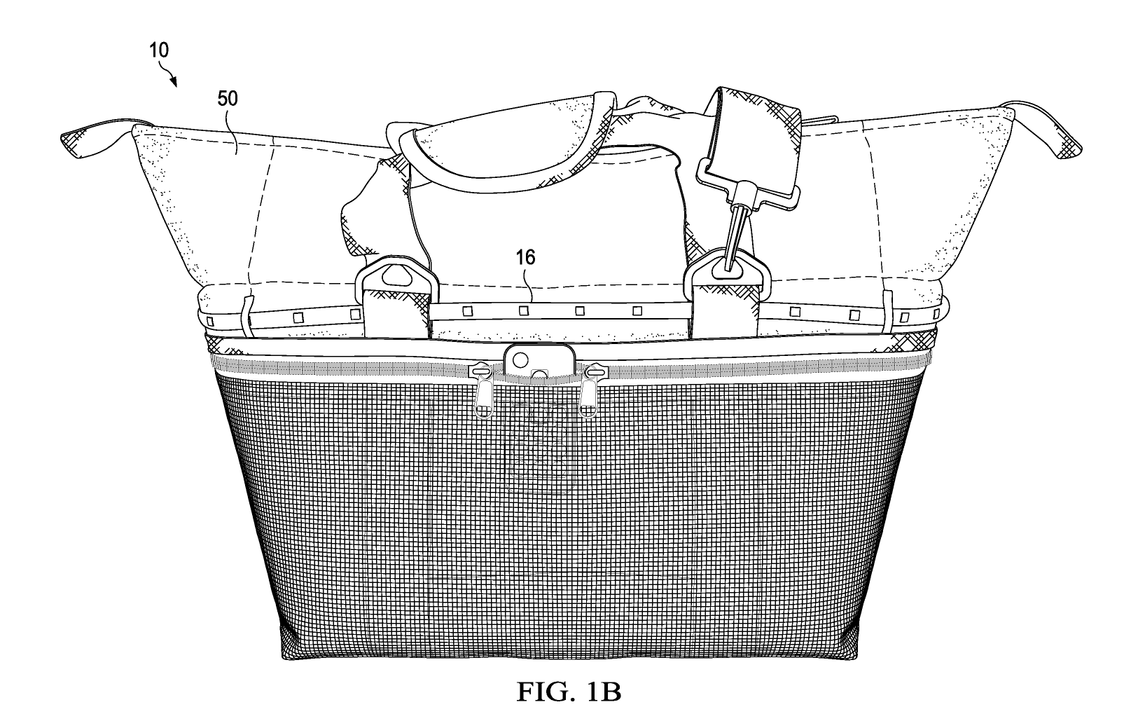

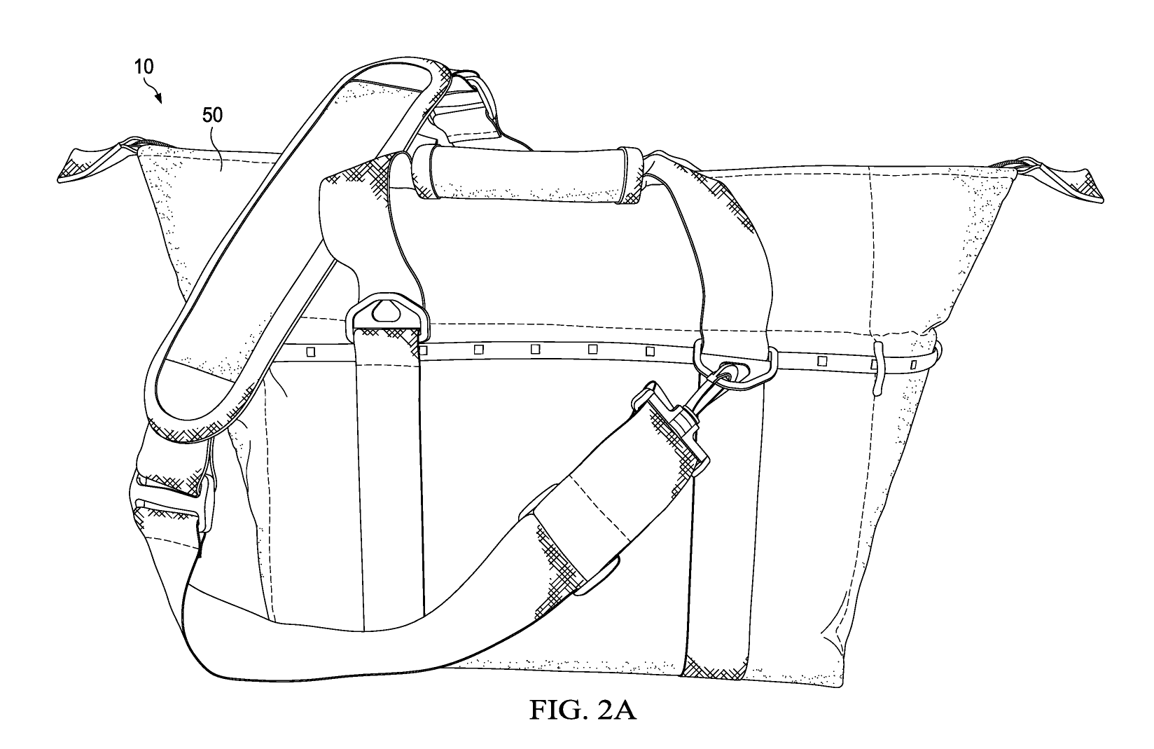

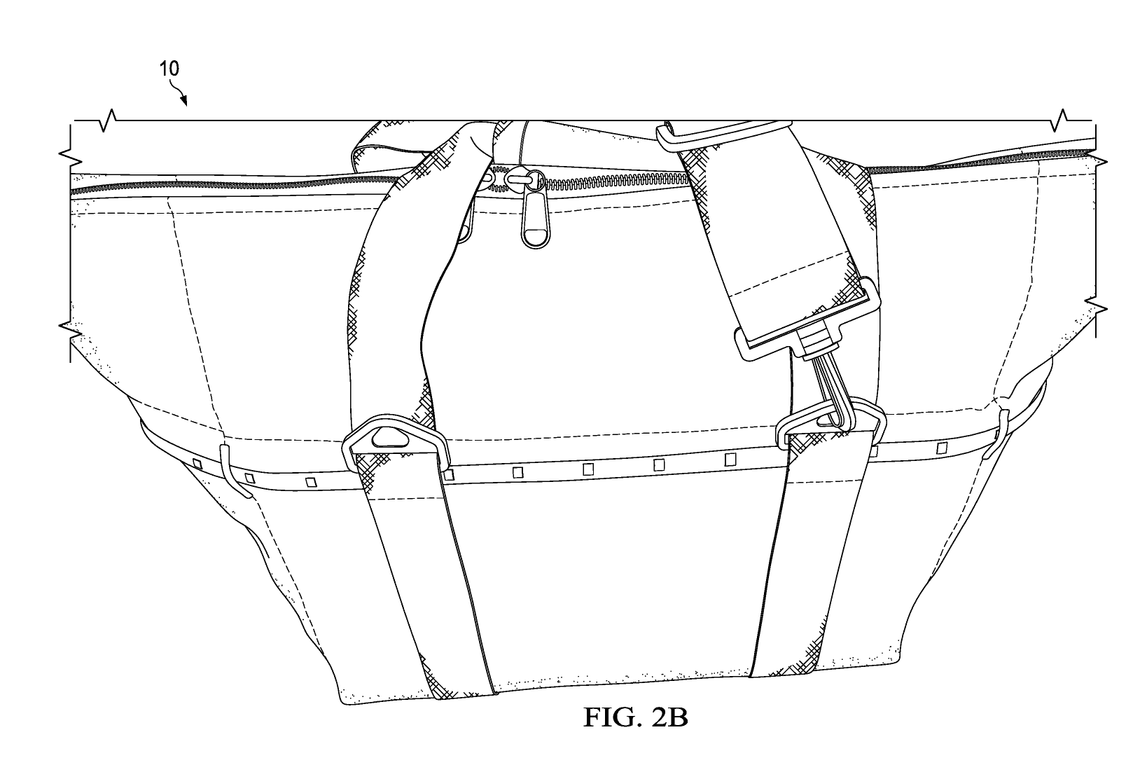

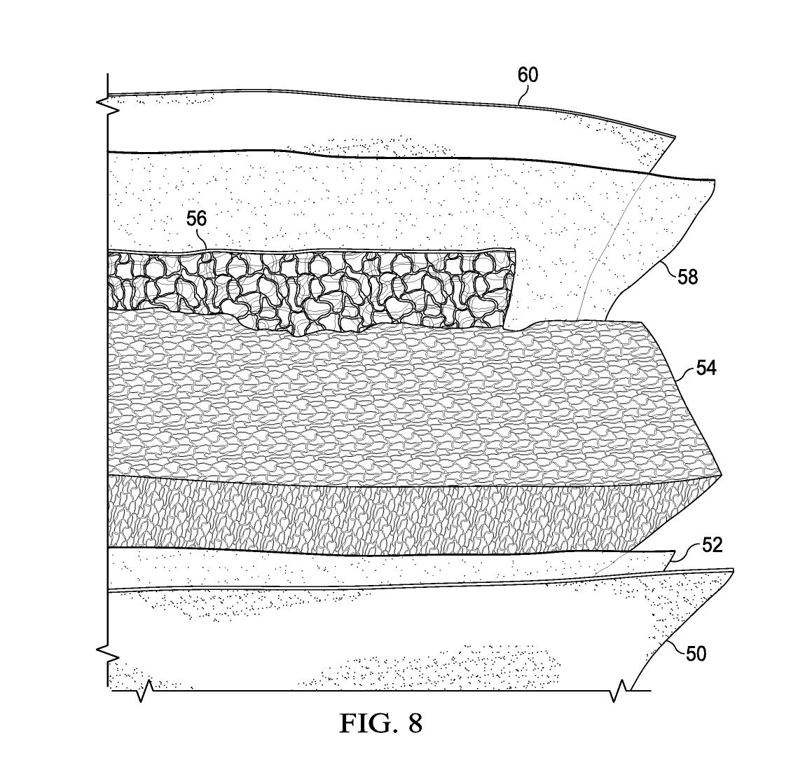

Referring to the Figures, FIGS. 1A-1B depict a front perspective view of a softsided cooler bag 10 and FIGS. 2A-2B depict a rear perspective view of the softsided cooler bag 10, according to embodiments of the disclosure. As shown in FIGS. 1A-1B and 2A-2B, softsided cooler bag 10 (hereinafter cooler bag 10) is a flexible multi-layered bag (shown in more detail in FIG. 8) that has a generally rectangular-shaped body 12 containing a main interior cavity (not shown), a fastener 14 and an illuminating lighting strip 16. A size of the cooler bag 10 may be configured in various shapes and sizes to define a main interior cavity (not shown) to hold various beverages and other foods that are intended to stay cold just prior to consumption. In one example, the main interior cavity may be configured to hold either nine 12-ounce (oz) cans of beverages, eighteen 12-oz cans of beverages, or a combination of various 12-oz beverages and other foods. A fastener 14 may be coupled to an upper end of the cooler bag 10 to selectively close or selectively open the upper end. In an embodiment, fastener 14 may be a zipper comprising of two flexible strips of metal or plastic with interlocking projections that may be selectively closed or opened by pulling a slide along them. The fastener 14 functions to provide selective access to the main interior cavity of the cooler bag 10 by selectively opening the fastener 14 from its closed position or preventing access to the main interior cavity by selectively closing the fastener 14 from its open position.

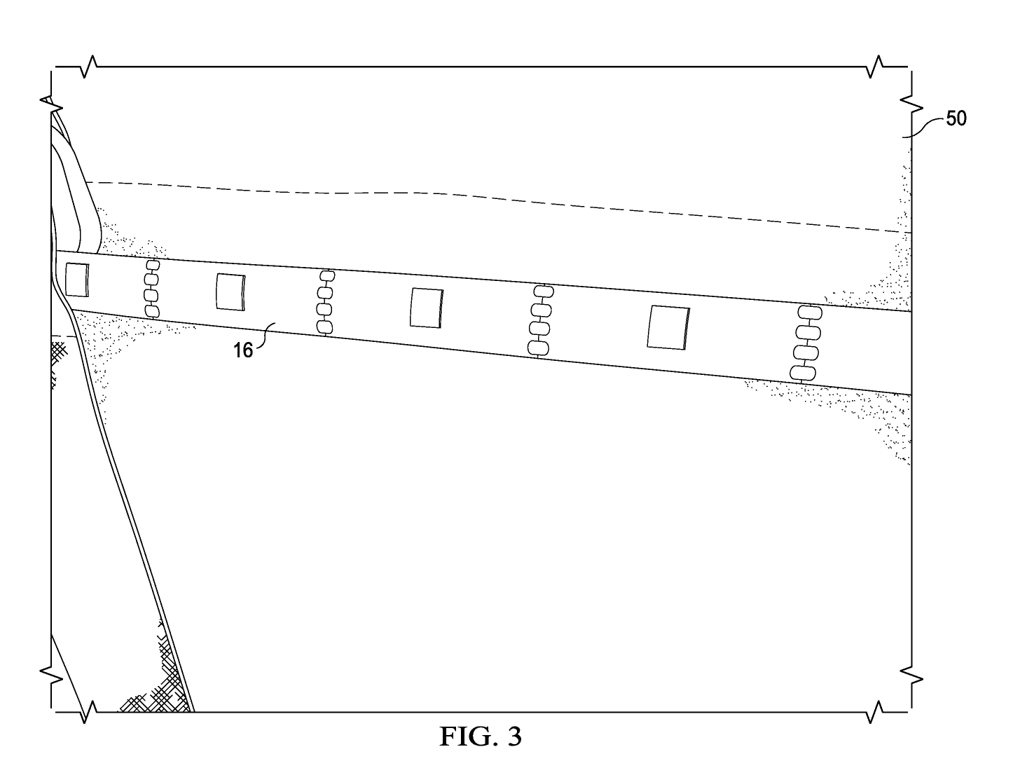

Referring now to FIG. 3, the lighting strip 16 may comprise a flexible strip of light emitting diodes (LEDs) (also referred to as lighting strip) that may be selectively coupled to an outer/exterior surface of the outer or outside shell 50 of the cooler bag 10. In addition to providing the lighting strip 16 on an exterior surface, a LED lighting strip substantially similar to LED lighting strip 16 may be provided on an exposed surface of an inside shell within the main interior cavity of the cooler bag 10 to illuminate the interior cavity. Other locations on the exterior of the cooler bag 10 may also contain LED lighting strips, in embodiments. In one non-limiting example, lighting strip 16 may include surface mount device (SMD) LED's with water proof color LED's such as, for example, a lighting strip of a SMD 5050, having a high brightness LED, Direct Current (DC) 5 Volt, 7.2 Watt per meter and 30 LED's per meter, International Protection code 65 (IP65). The LED lighting strip 16 may be illuminated with power from, for example, a 5 Volt (V) battery that may be housed in a weatherproof battery box within a compartment in the cooler bag 10. In other non-limiting examples, the LED lighting strip 16 may be powered by alkaline batteries or rechargeable batteries in the battery box and/or powered from a 12V auxiliary power outlet of an automobile to power the LED lighting strip 16 and/or recharge the batteries in the battery box.

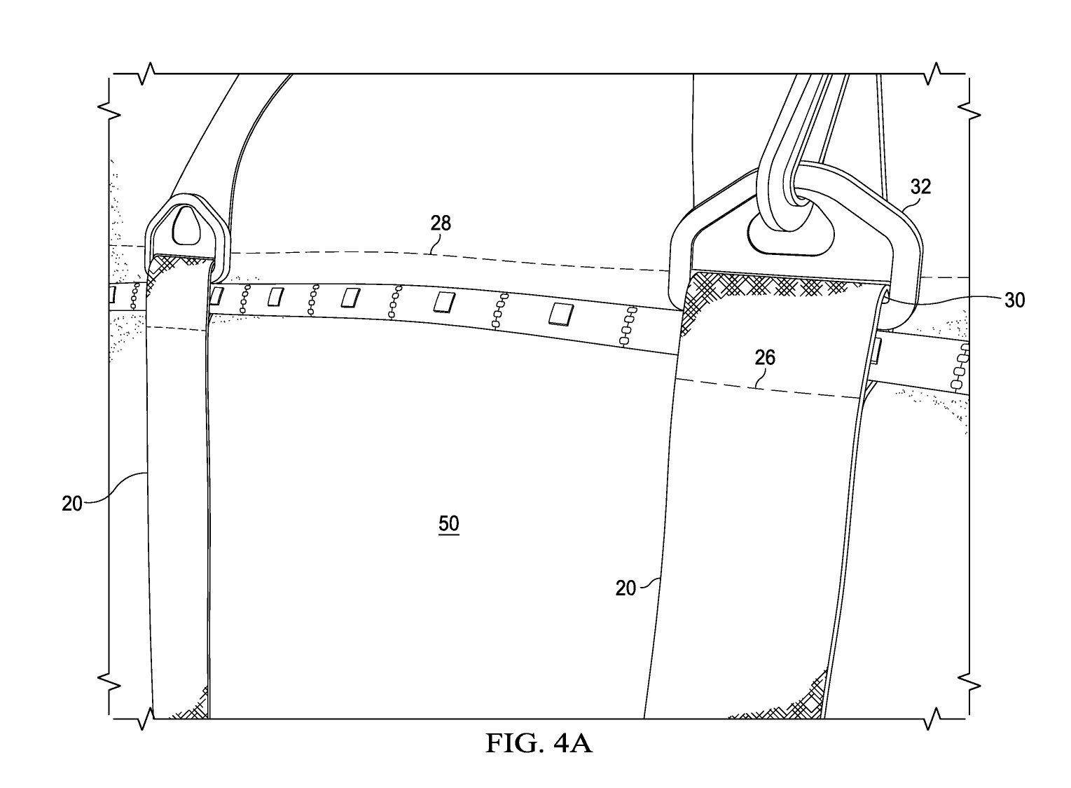

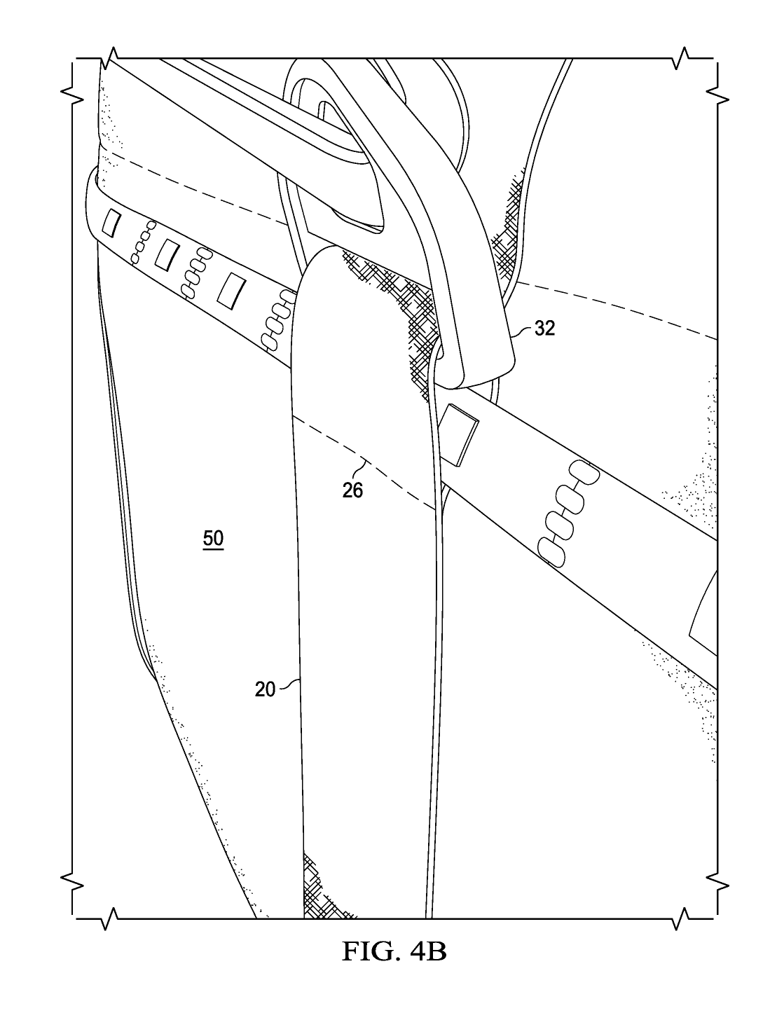

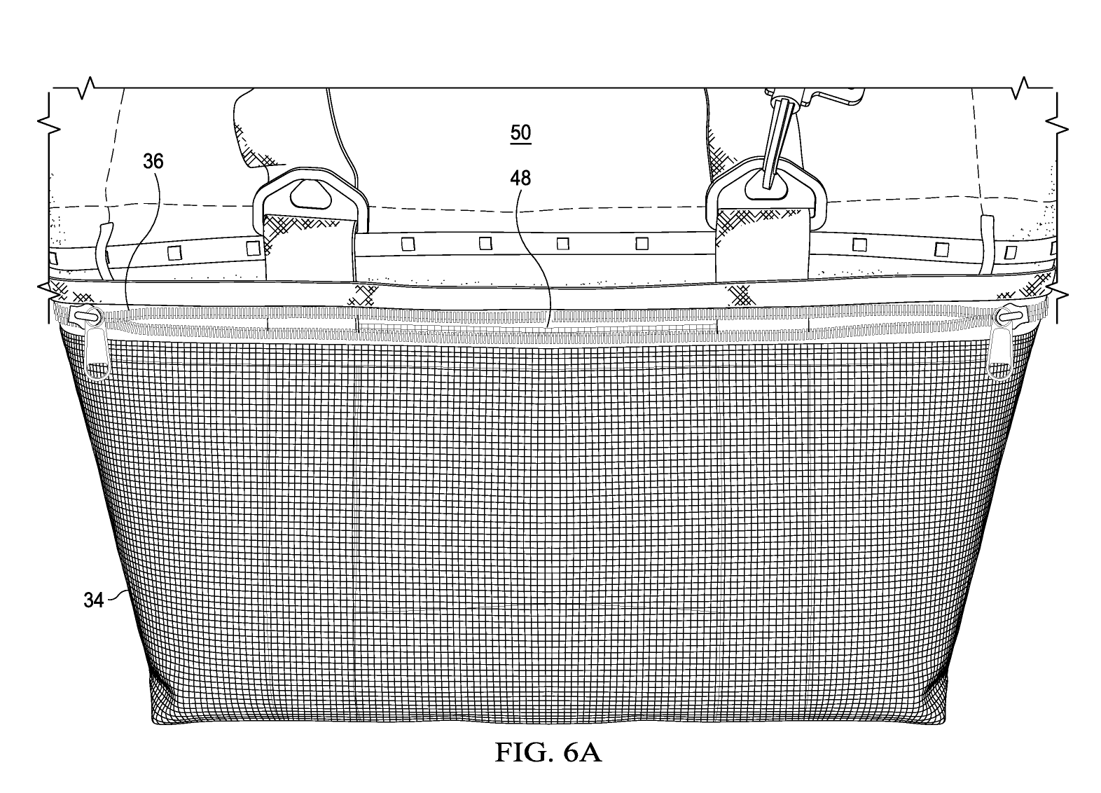

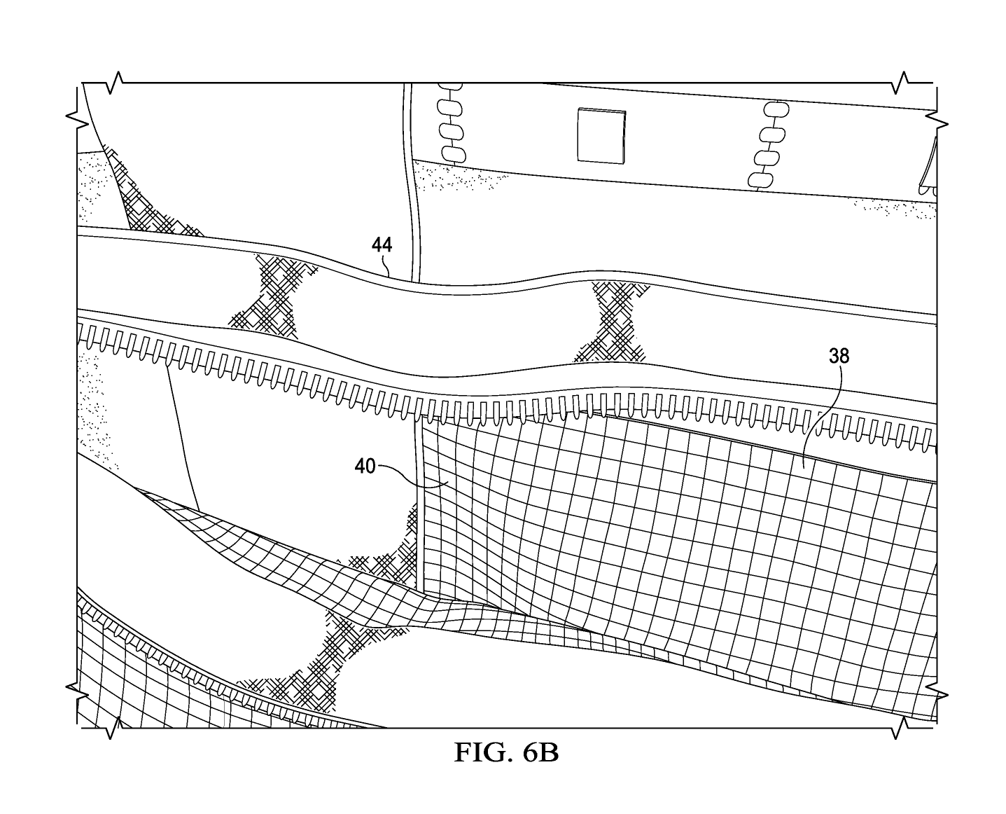

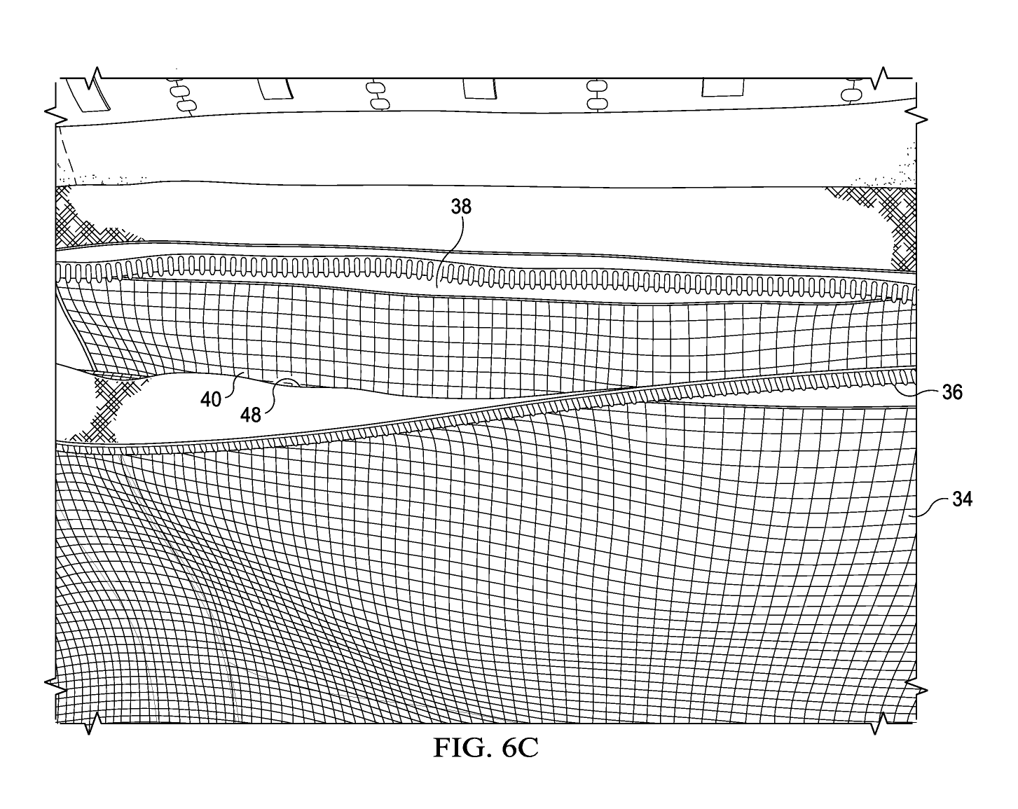

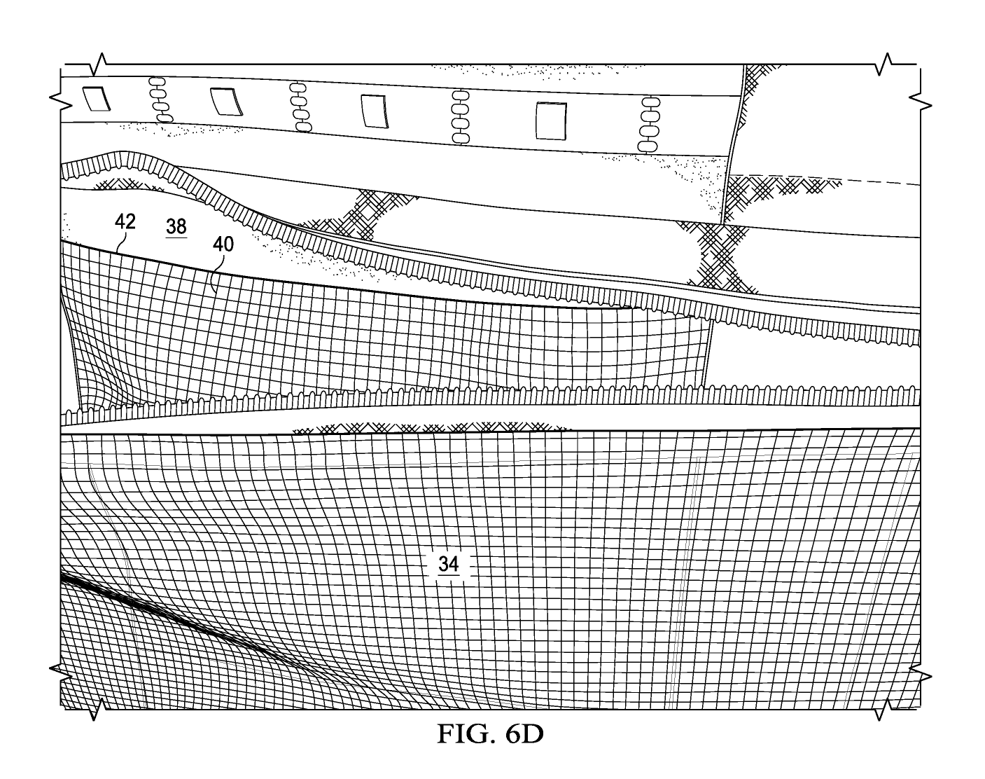

As shown in FIGS. 4A-4B and with continued reference to FIG. 1A, cooler bag 10 includes nylon straps 20, nylon cord loops 22, and a main mesh pocket 48 (also shown in FIG. 6A). Each nylon strap 20 is made from a woven nylon material and may be 1.5 inches wide and 40 inches long. Other dimensions for the nylon straps 20 may also be contemplated for use with the cooler bag 10. There are two nylon straps 20 that are coupled to exterior surface of outer shell 50, one at the front and the other at the rear of the cooler bag 10, in order to create body support, grab handles for carrying cooler bag 10, and for securely fastening mounting D-rings 32 to the cooler bag 10.

The D-rings 32 are configured to attach accessories such as a shoulder strap 24 in order to also provide a way to carry the cooler bag 10 on the shoulder of a user of the cooler bag 10. At the location of the D-rings 32, the nylon straps 20 may include an additional horizontal stitching pattern 26 for coupling the nylon strap 20 to the outer shell 50, which provides a channel space 30 around each D-ring 32 (i.e., between stitching pattern 28 along main stitching pattern and horizontal stitching pattern 26). The channel space 30 is configured to receive a loop of the D-ring 32 and securely couple the D-ring 32 to the outer shell 50. The lighting strip 16 fits tightly through the channel space 30 under the D-ring 32 allowing the nylon strap 20 to hold the lighting strip 16 securely against the outside shell while the bag is in use. The channel space 30 also allows the D-ring 32 to function normally without interfering with the lighting strip 16 as the horizontal stitching pattern 26 prevents the D-ring 32 from contacting the lighting strip 16.

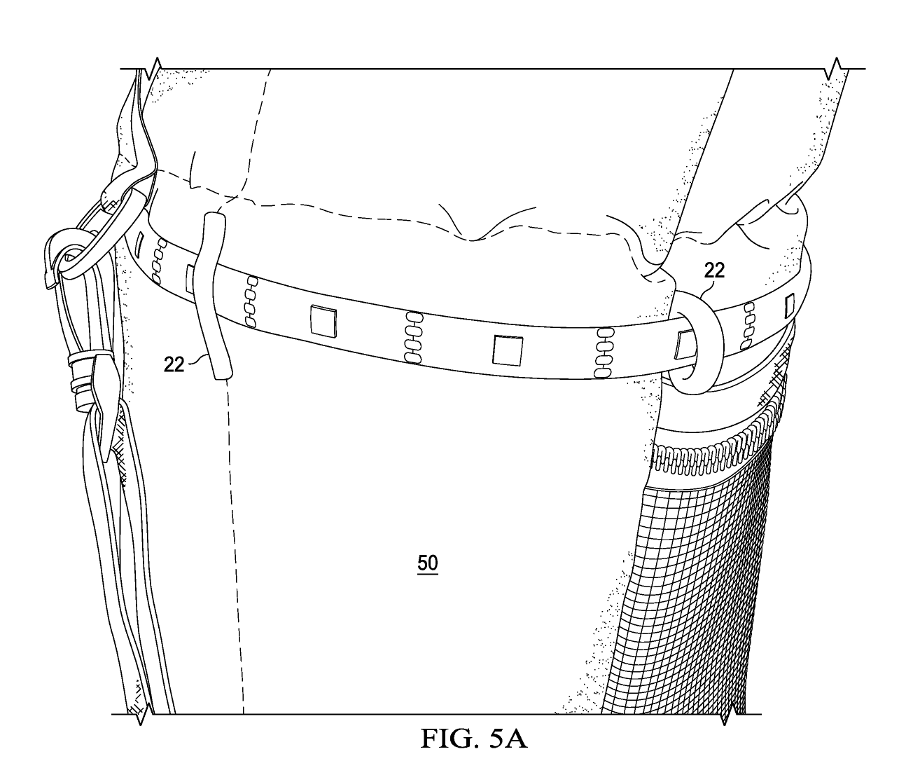

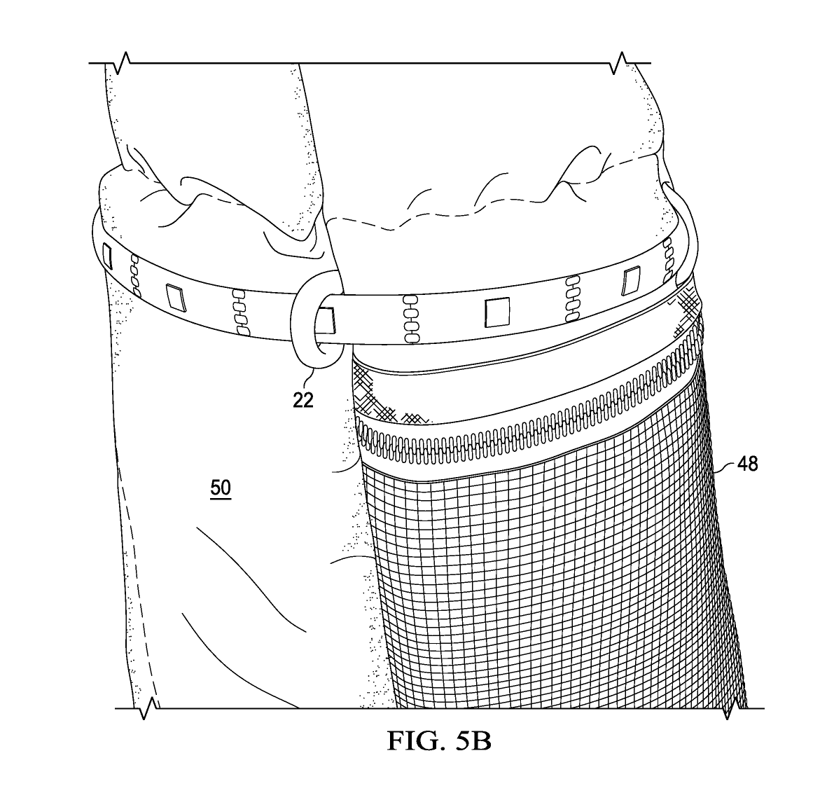

As shown in FIGS. 5A-5B, there are six nylon cord loops 22 that are arranged circumferentially around the rectangular-shaped body on an exterior surface of outer shell 50 (FIG. 1A) of cooler bag 10. Each nylon cord loop 22 is generally a nylon-coated flexible strip of woven material with a length of 1.5 inches and a width of 3/16 inch. A respective end of a length of nylon cord may be attached in a loop to only the outer shell 50 to form a nylon cord loop 22. Two nylon cord loops 22 may be positioned 4 inches from each end on the left and right side of the cooler bag 10 and four nylon cord loops 22 may be positioned at the vertical stitch seam. The nylon cord loops 22 provide an opening within each nylon cord loop 22 that functions to receive the lighting strip 16 within the opening of each nylon cord loop 22. The lighting strip 16 fits securely through the loop opening and is held to the outer shell 50 within the nylon cord loop 22 without the need for glue, hook and loops, or other fasteners that are prone to potentially degrading the connecting glue or mechanism in the environment. The nylon cord loops 22 also function to make the lighting strips 16 conform to the shape of the cooler bag 10 when the cooler bag 10 flexes during use. In other non-limiting examples, additional nylon cord loops substantially similar to nylon cord loop 22 may be provided on an interior shell within the main interior cavity to receive that additional lighting strip on the inside of the cooler bag 10.

FIGS. 6A-6D depicts a mesh material 34 that forms a main mesh pocket/compartment 48 on one side of cooler bag 10 according to an embodiment. A mesh material 34 used to make the main mesh pocket 48 is generally made from a mesh weave material that is coupled to either a front side or a read side of the cooler bag 10 to form the mesh pocket 48. In one example, the mesh material 34 may be 23 inches by 8 inches. A zipper 36 may be coupled to an upper edge of the mesh material 34 to selectively close or selectively open the main mesh pocket 48. In an embodiment, the zipper 36 may comprise of two flexible strips of metal or plastic with interlocking projections attached to a fabric that may be selectively closed or opened by pulling a slide along them. The zipper 36 may be 1¼ inches wide. The zipper 36 functions to provide selective access to the main mesh pocket 48 and other interior pockets (for example, hidden pocket 38) behind the mesh material 34 of the cooler bag 10.

Also shown in FIGS. 6B-6D, a hidden pocket 38 may be provided inside the main mesh pocket 48 and configured to securely hold a waterproof battery box and to also not interfere with the use of the main mesh pocket 48. The hidden pocket 38 is formed by attaching a second mesh material 40 to the outer shell 50 (FIG. 6A) within the mesh material of the main mesh pocket 48. The mesh material 40 is attached to outer shell 50 with a top edge 42 (FIG. 6D) of mesh material 40 fitting securely under the top of the top flexible strip of the zipper 36. In one example, the top edge 42 is ¾ inch from the top of the zipper strip. As the zipper 36 is 1¼ inches wide, the top edge 42 of the hidden pocket 38 is covered and kept closed by the top ½ inch of the zipper cloth fabric. With the top edge 42 fitting securely under the top flexible strip of the zipper 36, the top edge 42 of the hidden pocket 38 is kept closed from the pressure of the zipper 36 strip. This allows easy access to the battery compartment when needed but also keeps the hidden pocket 38 separate from the main mesh pocket 48. When sewing the zipper 36 to the outer shell 50 of the cooler bag 10, a space 44 of 1 inch (shown in FIG. 6B) is left unsewn to allow a power supply cord to reach the lighting strip 16 from the hidden pocket 38. This space 44 also allows wires to stay within the main mesh pocket 48 and thereby kept secure and hidden from view at all times.

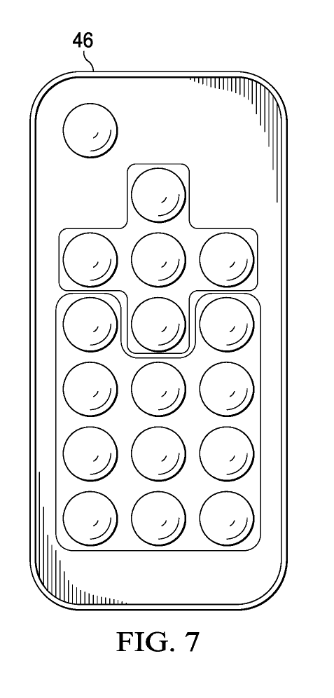

FIG. 7 depicts a top perspective view of a wireless controller 46 that may control operation of lighting strip 16 remotely according to an embodiment. In an embodiment, wireless controller 46 is a 17 key remote control that can control one or more functions of the lighting strip 16 including 20 different dynamic modes, 20 different colors, static mode, 5-level dynamic speed adjust, 5-level brightness adjustment, and 7-color static quick adjustment key. In an example, selecting a color button representing a color of the LED may selectively activate the LED of the color associated with the button or selectively disable the LED associated with the color button. The wireless controller 46 may remotely control the lighting strip 16 from up to a maximum distance of 10 meters (about 32 feet).

FIG. 8 depicts a cross-section of the different layers of a multi-layered cooler bag 10 according to an embodiment. The multi-layered cooler bag 10 may comprise two or more layers of flexible cloth or material for constructing the cooler bag 10. When two-layers are used, the layers comprise an outside shell and an inner liner. However, additional layers may be contemplated for use in cooler bag 10 based on user preferences in order to provide added insulation and durability. In one non-limiting example, a six-layer cooler bag may be constructed with an outer shell 50, a clear liner 52, a white foam 54, an open cell foam 56, a foam mesh 58, and an inner liner 60. The outer shell 50 is the exterior of the cooler bag 10 and may be made from industrial 18 oz industrial coated ultraviolet (UV) and anti-mildew treated vinyl polyester. The outer shell 50 is directly attached to the clear liner 52. Clear liner 52 may be a clear plastic moisture barrier material. Clear liner 52 is coupled to a white foam 54. White foam 54 may be a high density foam material with that has a compression rate of 30 pounds (lbs) for providing maximum insulation and flexibility. Coupled to the white foam 54 is open cell foam 56 that may be an open cell ⅛ inch 0.160 charcoal foam with fabric. A foam mesh 58 is coupled to the open cell foam 56 and may be a ½ oz spunbond backing that provides stitch reinforcement. An inner liner 60 forms the innermost layer of cooler bag 10 (FIG. 1A) and may be a heavy duty 15 gauge polyvinyl chloride (PVC) ultrasonic-welded leak proof liner that is tolerant up to −20 degree Celsius.

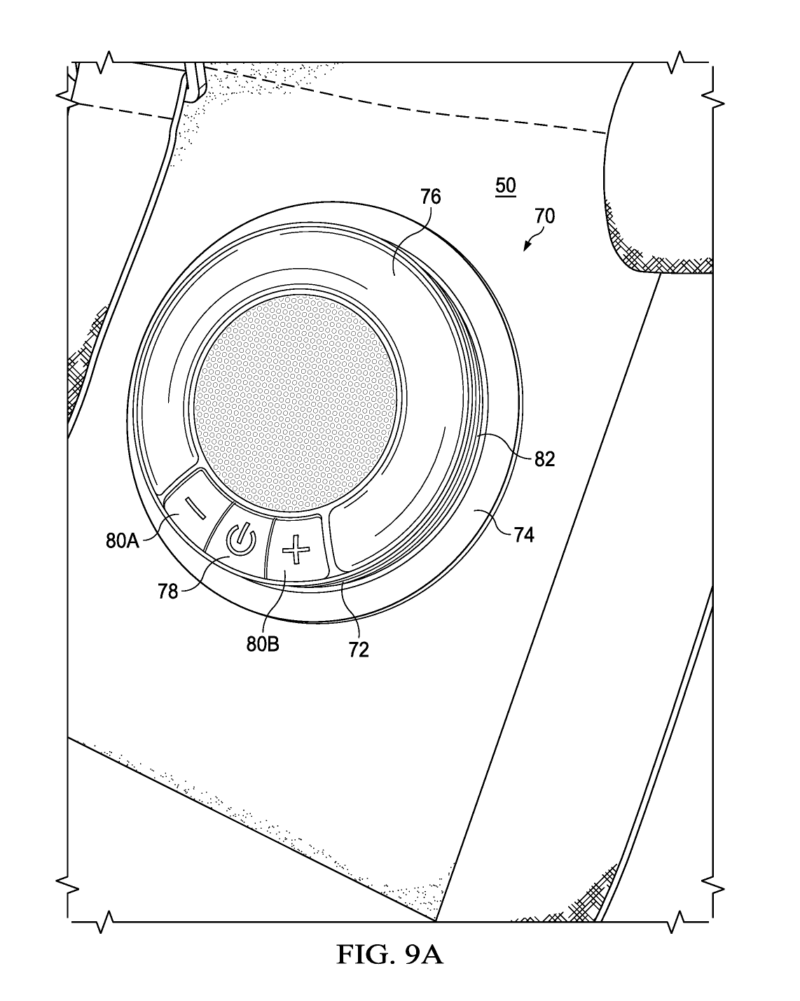

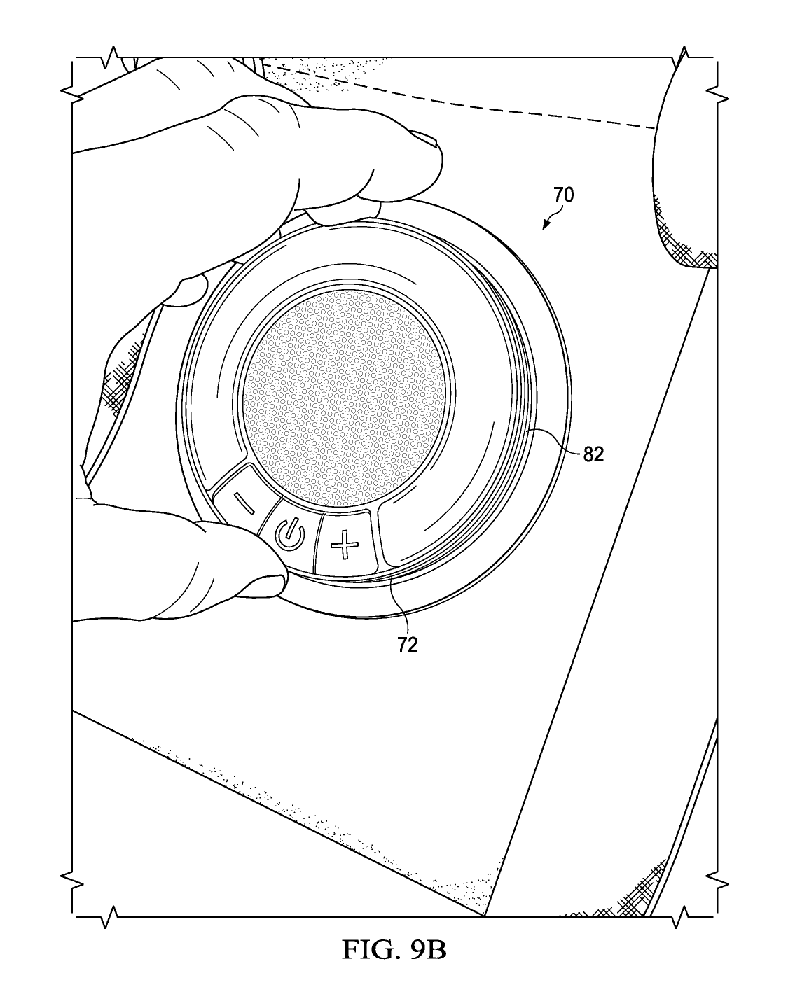

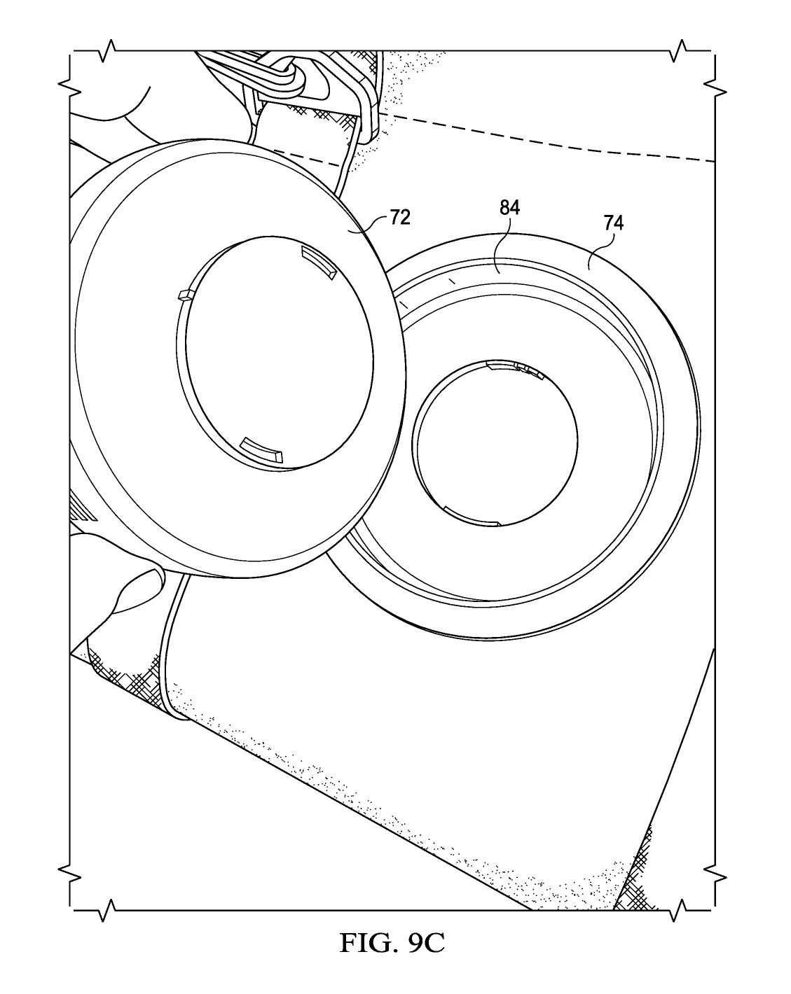

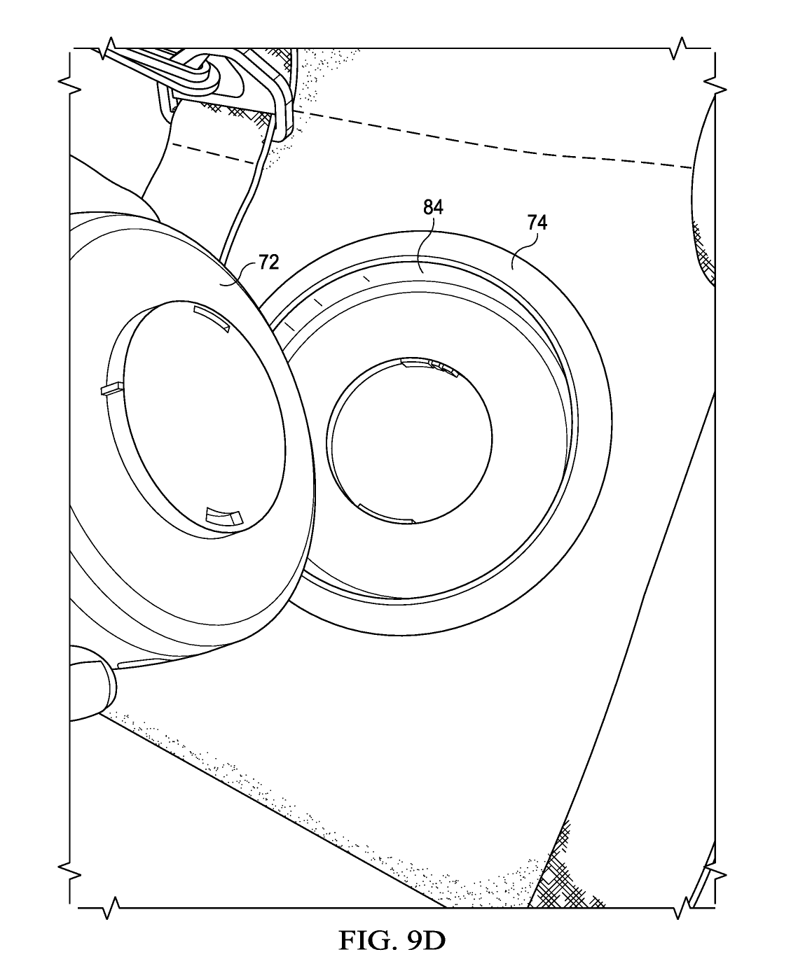

FIGS. 9A-9D depict a perspective view of a speaker assembly 70 for use with the cooler bag 10 of FIG. 1A according to an embodiment. In embodiments, speaker assembly 70 includes a lighted speaker 72 and a speaker holder 74. Lighted speaker 72 may be a BLUETOOTH compatible speaker that may wirelessly communicate to receive and/or transmit signals between a BLUETOOTH connected smartphone or other similar electronic device and lighted speaker 72. Lighted speaker 72 may include a lighting strip 76, a power button 78, and volume buttons 80A and 80B, that are contained within a speaker housing 82. The lighted speaker 72 may receive power from a rechargeable battery (not shown) that may be contained within speaker housing 82. A rechargeable battery may be configured to be charged via a universal serial bus (USB) port that may be provided on speaker housing 82. Lighting strip 76 may be provided along a circumference of the lighted speaker 72 and may include a plurality of LED lights that are housed in a translucent casing. In an embodiment, the plurality of LED lights may include multiple color LED lights that may be configured to change color or may be configured to display a single color when the lighted speaker 72 is powered on. The LED lights of lighting strip 76 may be powered by a 5 Volt (V) battery that may be housed in a weatherproof battery box within a compartment in the cooler bag 10. Alternatively, or in addition to being powered by the 5V battery, lighted speaker 72 may also be powered by a rechargeable battery that may be contained within the speaker housing 82. Power button 78 may be configured to turn-on or turn-off the lighted speaker 72, volume button 80A may be configured to decrease the volume of lighted speaker 72, and volume button 80B may be configured to increase the volume of lighted speaker 72. Power button 78 and volume buttons 80A-80B may be selectively controlled by applying a force or pressure on the buttons 78 and 80A-80B from, for example, a user's finger. Speaker assembly 70 also includes a speaker holder 74 that may be attached to outer shell 50 and is configured to receive lighted speaker 72. Speaker holder 74 may be generally circular in shape and may be selectively coupled to lighted speaker 72 via speaker housing 82 using threads, screws, pins, or similar attachment means. For instance, speaker housing 82 may include threads that are molded onto a bottom surface of speaker housing 82. An inside surface 84 (FIG. 9C) of speaker holder 74 may include complementary threads.

As shown in FIGS. 9B-9D, lighted speaker 72 may be removable from speaker holder 74. For instance, lighted speaker 72 may be selectively coupled to speaker holder 74 or selectively decoupled from speaker holder 74 using the complementary threads on both of the lighted speaker 72 and the speaker holder 74. In an embodiment, as shown in FIG. 9B, a user may selectively remove lighted speaker 72 from speaker holder 74 by grasping speaker housing 82 and twisting-off or rotating lighted speaker 72 in a direction that causes the lighted speaker 72 to twist-off. Using the twist-off motion, threads on lighted speaker 72 may be loosely coupled to complementary threads of speaker holder 74. Further, as shown in FIGS. 9C and 9D, vertically lifting the loosely coupled lighted speaker 72 from speaker holder 74 may selectively decouple the lighted speaker 72 from speaker holder 74. Similarly, lighted speaker 72 may be selectively coupled to speaker holder 74 from its detached position to form speaker assembly 70. For instance, threads of speaker housing 82 may be loosely coupled to the complementary threads of speaker holder 74 and rotating or twisting the speaker housing 82 causes the complementary threads of the speaker housing 82 and speaker holder 74 to engage each other, causing the lighted speaker 72 to form a friction fit with the speaker housing 82.

The terminology used herein is for the purpose of describing particular embodiments only and is not intended to be limiting of the invention. While the description of the disclosure has been presented for purposes of illustration and description, it is not intended to be exhaustive or limited to the invention in the form disclosed. Further, while described in the context of the cooler bag, it is understood that aspects can be used in other contexts in which a lighting strip may be coupled to other layers of the bag. Many modifications, variations, alterations, substitutions, or equivalent arrangement not hereto described will be apparent to those of ordinary skill in the art without departing from the scope and spirit of the invention. Additionally, while the various embodiment of the disclosure have been described, it is to be understood that aspects of the disclosure may include only some of the described embodiments.

What is claimed is:

1. An insulated container, comprising:
a plurality of flexible layers coupled together to form a body of the insulated container, wherein the plurality of flexible layers comprises an outer shell;
a plurality of segments coupled to an exterior surface of the outer shell, wherein each of the plurality of segments forms a loop;
a plurality of flexible straps coupled to the exterior surface of the outer shell, wherein each of the flexible straps provides a channel along a longitudinal axis of the insulated container; and
a lighting strip passing through the loop formed by each of the plurality of segments and through the channel provided by each of the flexible straps to secure the lighting strip to the insulated container.

2. The insulated container of claim 1, wherein the lighting strip includes a plurality of light emitting diodes (LEDs) spaced apart from each other.

3. The insulated container of claim 1, wherein the lighting strip is flexible and water-proof.

4. The insulated container of claim 1, wherein the insulated container supports a battery configured to power the lighting strip.

5. The insulated container of claim 1, wherein the lighting strip extends entirely around the insulated container.

6. The insulated container of claim 1, wherein the lighting strip is configured to be selectively removed from the loop formed by each of the plurality of segments and through the channel provided by each of the flexible straps to temporarily detach the lighting strip from the insulated container.

7. The insulated container of claim 1, wherein an additional lighting strip is secured to an interior of the insulated container.

8. An insulated container, comprising:
a plurality of flexible layers coupled together to form a body of the insulated container, wherein the plurality of flexible layers comprises an outer shell; and
a removable lighted speaker configured to be coupled to, and temporarily decoupled from, the outer shell.

9. The insulated container of claim 8, wherein the removable lighted speaker contains a battery configured to power the removable lighted speaker.

10. The insulated container of claim 8, wherein the removable lighted speaker includes a light emitting diode (LED) ring.

11. The insulated container of claim 10, wherein the LED ring extends around a periphery of the removable lighted speaker.

12. The insulated container of claim 8, wherein the removable lighted speaker is coupled and decoupled from the outer shell by rotating the removable lighted speaker relative to the outer shell.

13. The insulated container of claim 8, wherein the outer shell contains a cavity sized and configured to receive the removable lighted speaker.

14. The insulated container of claim 8, wherein the removable lighted speaker is rechargeable via a universal serial bus (USB) connector.

15. The insulated container of claim 8, wherein the removable lighted speaker is configured to engage in wireless communication.

16. An insulated container, comprising:
a plurality of flexible layers coupled together to form a body of the insulated container, wherein the plurality of flexible layers comprises an outer shell;
a removable lighted speaker configured to be coupled to, and temporarily decoupled from, the outer shell;
a plurality of segments coupled to an exterior surface of the outer shell, wherein each of the plurality of segments forms a loop;
a plurality of flexible straps coupled to the exterior surface of the outer shell, wherein each of the flexible straps provides a channel along a longitudinal axis of the insulated container; and
a lighting strip passing through the loop formed by each of the plurality of segments and through the channel provided by each of the flexible straps to secure the lighting strip to the insulated container.

17. The insulated container of claim 16, wherein the lighting strip includes a plurality of light emitting diodes (LEDs) spaced apart from each other.

18. The insulated container of claim 16, wherein the insulated container supports a battery configured to power the lighting strip, and the lighting strip extends entirely around the insulated container.

19. The insulated container of claim 16, wherein the removable lighted speaker is coupled and decoupled from the outer shell by rotating the removable lighted speaker relative to the outer shell.

20. The insulated container of claim 16, wherein the outer shell contains a cavity sized and configured to receive the removable lighted speaker.
